(19) United States
(12) Patent Application Publication
(10) Pub. No.: US 2011/0042485 A1
(43) Pub. Date: Feb. 24, 2011

(54) Adjustable Sprinkler Assembly

(75) Inventors: Edward L. McNulty, Midland, VA (US); Gary A. Cordova, Catlett, VA (US); James Meier, Stafford, VA (US)

Correspondence Address: DIEDERIKS & WHITELAW, PLC, 13885 HEDGEWOOD DR., SUITE 317, WOODBRIDGE, VA, 22193, US

(73) Assignee: JEG, INC., Midland, VA (US)

(21) Appl. No.: 12/544,297

(22) Filed: Aug. 20, 2009

(51) Int. Cl. B05B 15/10

(52) U.S. Cl. 239/203

(57) ABSTRACT

An adjustable sprinkler assembly incorporates a main housing including a cylindrical side wall having a first end portion that leads to a second end portion through an intermediate portion having a hollow interior. A riser member is shiftably mounted relative to the main housing to provide for adjustment of a sprinkler head attached thereto. An adjuster member, including an adjustment zone defined by a plurality of notches interconnected by a longitudinally extending groove, interconnects the riser member and the main housing. A stop member, mounted at the second end portion of the main housing, cooperates with the adjuster member to establish a desired positioning of a sprinkler head relative to the main housing.

### BACKGROUND OF THE INVENTION

1. Field of the Invention

The present invention pertains to the art of sprinkler systems and, more particularly, to an adjustable sprinkler assembly for a subterranean sprinkler network.

2. Discussion of the Prior Art

Subterranean irrigation or sprinkler networks having a number of vertically adjustable sprinkler assemblies connected to one or more main supply lines are widely known in the art. Typically, each sprinkler assembly includes a sprinkler head selectively positioned and operated for delivering water to irrigate grass, flowers, trees and the like over a particular area or zone. Because it is often desired to arrange the sprinkler head substantially flush with surrounding terrain and the depth to which the main supply line is buried can vary between different installations, sprinkler assemblies also include risers that interconnect the sprinkler head and the sprinkler networks. In order to accommodate the variation in depth, risers are constructed in varying lengths. However, often times a sprinkler head that was initially, properly positioned will become recessed relative to the surrounding ground. This potential problem is typical in most golf course installations where sprinkler heads are often run over by work vehicles and golf carts.

For at least this reason, it is sometimes necessary to excavate about a recessed or sunken sprinkler head to replace or reposition the associated riser with a riser of a different length in order to reset the desired height or positioning. Obviously, this represents a time consuming and expensive undertaking. To address this concern, it has heretofore been proposed to provide for some adjustability of the sprinkler head itself. In such known arrangements, the sprinkler head can be vertically adjusted a limited degree relative an associated riser. Typically, these known adjustment systems require a much lower degree of excavation, or component disassembly. While these systems minimized excavation, adjustment generally requires various manipulations that can be cumbersome, require special tools and/or introduce dirt into the sprinkler head. Other systems require at least partial disassembly of the sprinkler head to access the adjustment mechanism.

Based on the above, there exists a need for various improvements in the art of underground sprinkler systems. More specifically, there exists a need in the art for a sprinkler head that can be readily and easily vertically repositioned without requiring excavation, complex mechanical adjustments, disassembly or complicated manipulations.

### SUMMARY OF THE INVENTION

The present invention is directed to an adjustable sprinkler assembly including a main housing having a cylindrical side wall provided with a first end portion that leads to a second end portion through an intermediate portion which collectively define a hollow interior portion. A riser member is shiftably mounted relative to the main housing to provide for adjustment of a sprinkler head attached thereto. The riser member includes an outer wall having a first end section that extends to a second end section through an intermediate section which collectively define an interior cavity. An adjuster member interconnects the riser member and the main housing and also provides for vertical displacement of the riser member to enable proper positioning of the sprinkler head.

In accordance with the invention, the adjuster member includes a main body portion having a first end which extends to a second end through an adjustment zone. The adjustment zone includes a first adjustment portion defined by a plurality of notches arranged at spaced longitudinal locations along the adjuster member, and a second adjustment portion defined by a groove extending longitudinally along the adjuster member. The groove is positioned adjacent to and interconnects each of the plurality of notches. A stop member, mounted at the second end portion of the main housing, cooperates with the adjuster member to establish a desired positioning of the riser member relative to the main housing.

The stop member is preferably in the form of a clip positioned in a groove or channel formed in the second end portion of the main housing. The clip includes at least one tab portion that projects into the hollow interior portion. The at least one tab portion is configured to engage with the plurality of notches to establish a desired position of the sprinkler head. The at least one tab portion is also configured to translate along the groove to allow the riser member to shift over the entire adjustment zone. More specifically, in one configuration, application of a downward force to the sprinkler assembly causes the plurality of notches to ratchet along the at least one tab portion to decrease a relative distance between the sprinkler head and the main housing. In another configuration, the at least one tab portion transitions into the groove. The transition is achieved through a small rotation of the riser member. At this point, the sprinkler head is free to move along the entire adjustment zone to set a desired position.

In accordance with one aspect of the invention, the second end of the adjuster member is provided with an O-ring that seals against interior wall portions of the main housing. Preferably the second end of the adjuster member is provided with multiple O-rings to ensure that water, flowing to the sprinkler head, does not leak past the adjuster member and exit directly from the main housing. The O-rings also prevent dirt and other debris from entering into interior portions of the sprinkler assembly. In accordance with another aspect of the invention, the first end of the main housing is provided with a plurality of threads that are adapted to receive a locking collar provided on a fitting that is attached to a terminal end of a feeder pipe portion of an overall sprinkler system. Most preferably, the feeder pipe and main housing interconnect through a ball and socket arrangement that provides angular adjustment for the sprinkler head.

Additional objects, features and advantages of the present invention will become more readily apparent from the following detailed description of a preferred embodiment when taken in conjunction with the drawings wherein like reference numerals refer to corresponding parts in the several views.

### BRIEF DESCRIPTION OF THE DRAWINGS

FIG. 1 is a perspective view of an adjustable sprinkler assembly constructed in accordance with the present invention provided as part of a subterranean irrigation system;

FIG. 2 is a cross-sectional side view of an adjuster portion of the adjustable sprinkler assembly of FIG. 1;

FIG. 3 is an elevational view of a main housing of the adjuster portion of FIG. 2;

FIG. 4 is an elevational view of an adjuster member of the adjuster portion of FIG. 2;

FIG. 5 is a partial side, cross-sectional view, of an adjustment portion of the adjuster member of FIG. 4;

FIG. 6 is a cross-sectional slice taken at A-A of the adjuster member of FIG. 4;

FIG. 7 is a plan view of a stop member employed in connection with the present invention; and

FIG. 8 depicts the stop member of FIG. 7 interacting with the adjuster member of FIGS. 4 and 6.

### DETAILED DESCRIPTION OF THE PREFERRED EMBODIMENT

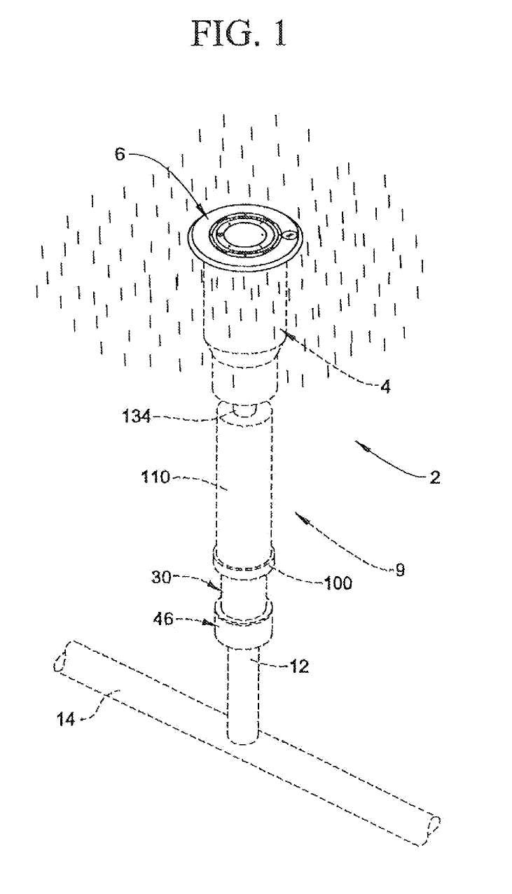

With initial reference to FIG. 1, an adjustable sprinkler assembly constructed in accordance with the present invention is generally indicated at 2. Sprinkler assembly 2 includes a sprinkler head 4 having a cap portion 6 and an adjuster portion 9. Adjuster portion 9 interconnects sprinkler head 4 with a feeder pipe 12 that extends from a subterranean irrigation system 14. As will be discussed more fully below, adjuster portion 9 enables installers to accurately position sprinkler head 4 relative to an upper surface of, for example, a lawn. That is, it is often desirable to ensure that cap portion 6 remains substantially flush with the upper surface of the lawn while, at the same time, enabling a sprinkler member (not shown), provided within sprinkler head 4, to pop-up and distribute water to surrounding grass, shrubbery, flowers and the like.

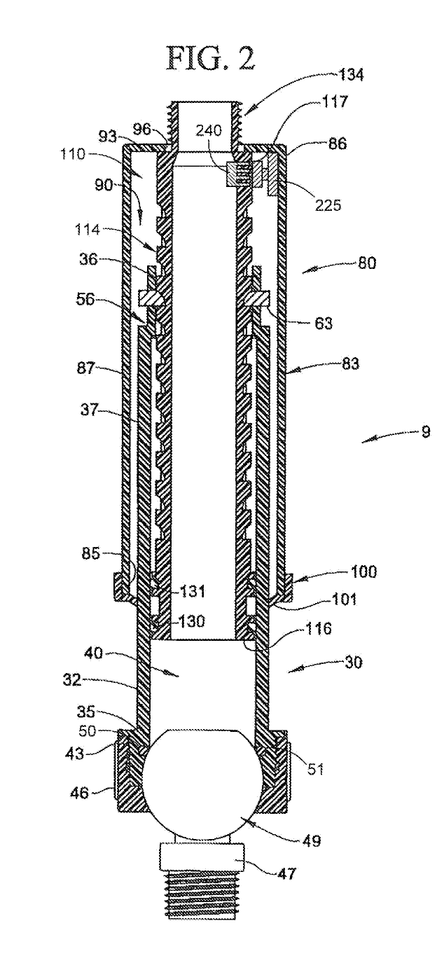

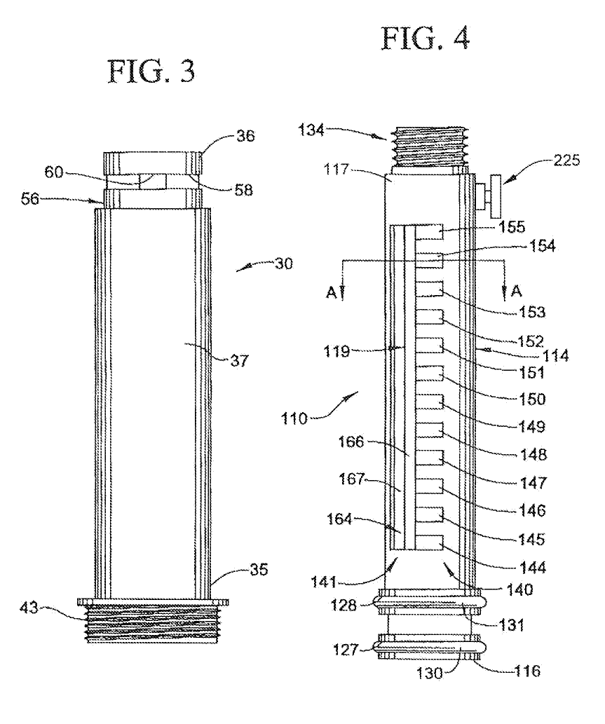

As best shown in FIGS. 2-4, adjuster portion 9 includes a main housing 30 having a generally cylindrical side wall 32 including a first end portion 35, a second end portion 36 and an intermediate portion 37 which collectively define a hollow interior portion 40. As shown, first end portion 35 includes an externally threaded section 43 which is designed to receive a collet or nut 46 provided as part of a connection fitting 47 provided on a terminal end portion of feeder pipe 12. More specifically, fitting 47 includes a ball 49 that is received by threaded section 43 and clamped or movably held in place by collet 46 to establish a ball and socket connection. The ball and socket connection enables main housing 30 to articulate about an axis defined by ball 49 and provides angular adjustment for sprinkler assembly 2. In order to prevent leaking, a generally, C-shaped annular groove 50 is formed in threaded section 43 and an O-ring 51 is positioned in groove 50 to seal between collet 46 and threaded section 43. Of course, it should be readily apparent that, while an O-ring is disclosed, various other sealing arrangements, such as washers formed from a variety of materials, Teflon® tape and the like, can also be employed. As best shown in FIG. 3, second end portion 36 of main housing 30 includes a stepped region 56. Stepped region 56 includes a groove or channel 58 having an opening 60 that leads to hollow interior portion 40. Channel 58 is designed to receive a stop member 63 that, as will be discussed more fully below, enables an installer to establish a vertical height adjustment for sprinkler head 4.

Referring back to FIG. 2, adjuster portion 9 includes a riser member 80 that is shiftily mounted relative to main housing 30. As shown, riser member 80 includes a side wall section 83 having a first end section 85 that leads to a second end section 86 through an intermediate section 87 which collectively define an interior cavity 90. Riser member 80 is further shown to include a top wall portion 93 having an opening 96, the purpose of which will be described more fully below. Riser member 80 is also shown to include a wiper or seal 100 provided on first end section 85. Wiper 100 includes an elastomeric gasket 101 that contacts and encircles cylindrical side wall 32 of main housing 30. Wiper 100 moves in conjunction with riser member 80 such that gasket 101 sliding over cylindrical side wall 32 to prevent dirt or other debris from entering into interior cavity 90.

In further accordance with the invention, sprinkler assembly 2 includes an adjuster member 110 that provides a mechanism for vertical height adjustment of sprinkler head 4. Adjuster member 110 includes a main body portion 114 having a first end 116 which leads to a second end 117 through an intermediate portion that defines an adjustment zone 119. As best shown in FIG. 4, adjuster member 110 includes a pair of grooves 127 and 128 arranged at first end 116. Grooves 127, 128 are designed to receive respective O-rings 130, 131 (also see FIG. 2) that seal against an inner surface (not separately labeled) of cylindrical side wall 32. Second end 117 of adjuster member 110 is provided with a threaded nipple 134 which is designed to project through opening 96 and connect with sprinkler head 4.

With this arrangement, water delivered through feeder pipe 12 enters hollow interior portion 40 of main housing 30, passes through adjustment member 110 to sprinkler head 4 before exiting sprinkler head 4 to irrigate a surrounding area. In order to properly position sprinkler head 4, adjuster member 110 is vertically shiftable through adjustment zone 119 relative to main housing 30. Towards that end, adjustment zone 119 includes first and second adjustment portions 140 and 141 that cooperate with stop member 63 to establish a desired vertical positioning of sprinkler head 4 as will be detailed more fully below.

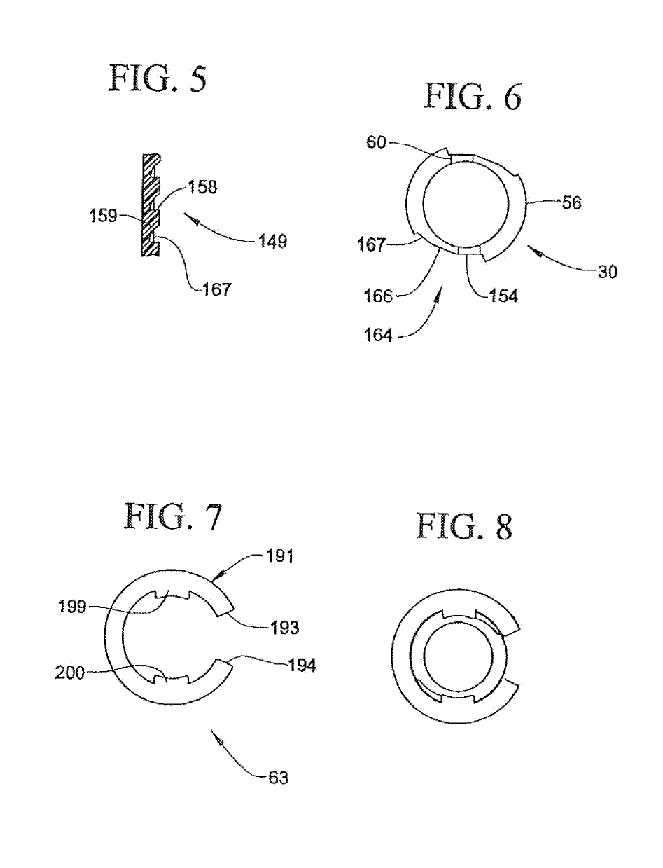

In accordance with the most preferred form of the invention shown in FIG. 4, first adjustment portion 140 includes a plurality of notches 144-155 that are arranged, at spaced longitudinal locations, along adjuster member 110. As best shown in FIG. 5, each notch 144-155 includes a first or flat area 158 that extends in a plane substantially perpendicular to an outer surface (not separately labeled) of main body portion 114 of adjuster member 110 and leads to a second or arcuate area 159 that projects upward and away from the outer surface. At this point, it should be understood that, while the description only references adjustment zone 119, adjuster member 110 includes a second adjustment zone (not separately labeled) arranged on an opposite side of main body portion 114.

In further accordance with the most preferred form of the invention, second adjustment zone 141 is defined by an elongated groove 164 that extends longitudinally along adjuster member 110. As shown, groove 164 is positioned adjacent to, and actually opens into, each of notches 144-155. As best shown in FIG. 6 which illustrates a cross-section of adjuster member 110 taken through notch 154, groove 164 includes a first section 166 that extends from notch 154 to a second section 167. Preferably, first and second sections 166 and 167 are slightly tapered relative to one another. As will be discussed more fully below, groove 164 enables sprinkler head 4 to be freely, vertically shifted through an entire length of adjustment zone 119 in both upward and downward directions.

Reference will now be made to FIG. 7 in describing a preferred construction of stop member 63. Stop member 63 includes an arcuate main body portion 191 having first and second end portions 193 and 194 which define a C-type clip. Stop member 63 is also provided with first and second opposing tab members 199 and 200 that extend laterally inward from main body portion 191. Stop member 63 is positioned within channel 58 (FIG. 3) with tab member 199 projecting through opening 60 and tab member 200 projecting through an opposing opening (not shown).

Reference will now be made to FIGS. 2-8 in describing a preferred method of operation of sprinkler head assembly 2. After connecting main housing 30 to feeder pipe 12, sprinkler head 4 is urged downward such that notches 144-155 ratchet along stop member 63 until a desired height or position of sprinkler head 4 is achieved. Ratcheting is accomplished by an interaction between stop member 63, which acts as a pawl, and first adjustment portion 140, which serves as a ratchet. Once lowered to a desired position, the configuration of notches 144-155 prevents any upward movement of sprinkler head 4. As there may be significant resistance to this lowering operation due to water in hollow interior portion 40, a pressure relief unit 225 having an associated one-way seal 240 is preferably provided at second end 117 of main body portion 114, as clearly shown in FIGS. 2 and 4, to control the pressure within adjuster member 110.

If adjustments are necessary, sprinkler head 4 can be raised and repositioned. Raising sprinkler head 4 is accomplished by imparting a slight rotation to adjuster member 10. As best shown in FIG. 8, rotation of adjuster member 110 shifts tab member 199 of stop member 63 into groove 164 and tab member 200 into the opposing groove (not separately labeled). More specifically, rotation of adjuster member 110 causes tab member 199 to move from, for example, notch 154 into first section 166 of groove 164. Of course, tab member 200 would also move in a corresponding manner. At this point, continued rotation of adjuster member 10 moves tab member 199 into second section 167 of groove 164. The relative angling of first and second sections 166 and 167 of groove 164 and corresponding relative angling of the opposing groove causes first and second end portions 193 and 194 of stop member 63 to spread or open. At this point, sprinkler head 4 can be raised with adjuster member 110 being free to transition through an entire length of adjustment zone 119 to achieve a desired position of sprinkler head 4.

With this arrangement, installers can readily install and orientate a sprinkler head relative to a ground surface. Moreover, the sprinkler head can be readily adjusted or set at a desired height without requiring special tools to achieve the adjustment. If, for example, ground in an area around the sprinkler head begins to erode, a person need simply press downward on the sprinkler head to re-establish a desired position through the permitted ratcheting action. Raising of the sprinkler head is also readily accommodated through the approximate quarter turn of the sprinkler head, followed by the lifting of the head, as described fully above. The degree of adjustment will vary depending on the length of the various components, with preferred embodiments providing for at least 3-6 inches (approximately 7.5-15.25 cm) in height adjustment. Although described with reference to a preferred embodiment of the invention, it should be readily understood that various changes and/or modifications can be made to the invention without departing from the spirit thereof. In general, the invention is only intended to be limited by the scope of the following claims.

I/we claim:

1. An adjustable sprinkler assembly comprising:
a main housing having a cylindrical side wall including a first end portion that leads to a second end portion though an intermediate portion having a hollow interior;
a riser member shiftably mounted relative to the main housing, said riser member including a side wall portion having a first end section that extends to a second end section through an intermediate section which collectively define an interior cavity;
an adjuster member interconnecting the riser member with the main housing, said adjuster member including a main body portion having a first end extending to a second end through an adjustment zone, said adjustment zone including a first adjustment portion defined by a plurality of notches extending longitudinally, at spaced locations, along the adjustment zone, and a second adjustment portion defined by a groove extending longitudinally along the adjustment zone alongside the plurality of notches; and
a stop member mounted at the second end portion of the main housing, said stop member cooperating with the adjuster member to establish a desired positioning of the riser member relative to the main housing, wherein application of a downward force upon the riser member causes the plurality of notches of the first adjustment portion to ratchet along the stop member to decrease a relative distance between the first end section of the riser member and first end portion of the main housing, and wherein rotation of the riser member relative to the main housing shifts the stop member into the second adjustment portion thereby enabling the riser member to transition along the entire adjustment zone to provide additional adjustment.

2. The adjustable sprinkler assembly according to claim 1, wherein each of the plurality of notches includes a first area that extends substantially perpendicularly outward from the main body portion of the adjuster member to a second area.

3. The adjustable sprinkler assembly according to claim 2, wherein the second area is arcuate and positioned above the first area.

4. The adjustable sprinkler assembly according to claim 1, wherein the groove extends adjacent to and interconnects each of the plurality of notches.

5. The adjustable sprinkler assembly according to claim 4, wherein the groove includes a first portion that extends to a second portion, said first portion being angled relative to the second portion.

6. The adjustable sprinkler assembly according to claim 1, further comprising: another adjustment zone including first and second adjustment portions defined by a plurality of notches and a groove respectively, said another adjustment zone being arranged opposite said adjustment zone on the adjuster member.

7. The adjustable sprinkler assembly according to claim 1, wherein the main housing is coupled to a feeder pipe through a ball and socket connection.

8. The adjustable sprinkler assembly according to claim 1, wherein the first end portion of the adjuster member includes a groove, said groove being provided with an O-ring adapted to seal against an internal surface of the main housing.

9. The adjustable sprinkler assembly according to claim 1, further comprising: a wiper mounted to the first end section of the riser member, said wiper including a gasket that encircles the main housing to prevent soil particles from entering the sprinkler assembly.

10. The adjustable sprinkler assembly according to claim 1, further comprising: a sprinkler head mounted directly to the adjuster member.

11. The adjustable sprinkler assembly according to claim 1, further comprising: a pressure relief valve provided along and controlling pressure within the adjuster member.

12. An adjustable sprinkler assembly comprising:
a main housing having a cylindrical side wall including a first end portion that leads to a second end portion through a hollow intermediate portion;
a riser member shiftably mounted relative to the main housing, said riser member including an outer wall having a first end section that extends to a second end section through an intermediate section which collectively define an interior cavity;
means for reducing a relative distance between the first end of the main housing and the first end of the riser member; and
means for increasing a relative distance between the first end of the main housing and the first end of the riser member.

13. The adjustable sprinkler assembly according to claim 12, wherein the main housing is coupled to a feeder pipe through a ball and socket connection.

14. The adjustable sprinkler assembly according to claim 12, wherein the first end portion of the adjuster member includes a groove, said groove being provided with an O-ring adapted to seal against an internal surface of the main housing.

15. The adjustable sprinkler assembly according to claim 12, further comprising: a wiper mounted to the first end portion of the riser member, said wiper including a gasket that encircles the main housing to prevent soil particles from entering the sprinkler assembly.

16. A method of vertically adjusting a sprinkler assembly having a main housing connected to a subterranean sprinkler network and an sprinkler head mounted to an adjuster member that is attached to the main housing for relative shifting movement by a riser member comprising:
applying a downward force to the sprinkler head causing a first adjustment portion of an adjuster member to ratchet along a stop member provided on the main housing to lower the sprinkler head; and
rotating the sprinkler head so that the stop member registers with a second adjustment portion of the adjuster member-to allow the riser member to shift freely throughout the adjustment zone to selectively reposition the sprinkler head if additional adjustment is required.

17. The method according to claim 16, wherein rotating the sprinkler head moves the stop member from a select one of a plurality of notches of the first adjuster portion into a groove of the second adjuster portion.

18. The method of claim 17, wherein the stop member guides along first and second relatively angled portions between each of the plurality of notches and the groove.

19. The method of claim 16, further comprising: wiping an outer surface of the main housing with a elastomeric gasket provided on the riser member upon vertical shifting of the sprinkler head.

20. The method of claim 16, further comprising: providing angular adjustment of the sprinkler head through a ball and socket arrangement interconnecting the main housing and the sprinkler network.
